(19) United States
(12) Patent Application Publication
(10) Pub. No.: US 2002/0144472 A1
(43) Pub. Date: Oct. 10, 2002

(54) Space-based mausoleum systems and associated methods

(75) Inventor: Charles M. Chafer, Houston, TX (US)

Correspondence Address: HOWREY SIMON ARNOLD & WHITE LLP, 1299 PENNSYLVANIA AVE., NW, BOX 34, WASHINGTON, DC, 20004, US

(73) Assignee: Celestis, Inc., Houston, TX

(21) Appl. No.: 10/063,273

(22) Filed: Apr. 5, 2002

Related U.S. Application Data
(60) Provisional application No. 60/281,417, filed on Apr. 5, 2001.

(51) Int. Cl. E04H 13/00; A61G 17/00

(52) U.S. Cl. 52/136; 27/1

(57) ABSTRACT

A space-based mausoleum system including a cabinet-like structure, a plurality of compartments disposed within the cabinet-like structure, and a plurality of containers disposed within the plurality of compartments, wherein the plurality of containers are operable for housing the remains of a plurality of deceased individuals. The cabinet-like structure can be fixedly or removably attached to a spacecraft, orbited around the Earth, or located upon the surface of a space-based body.

### Cross Reference to Related Applications

This non-provisional patent application claims the benefit of U.S. Provisional Patent Application No. 60/281,417, entitled “Space-Based Mausoleums,” filed Apr. 5, 2001.

### BACKGROUND OF INVENTION

The present invention relates generally to burial systems and methods, and also to memorial services. More specifically, the present invention relates to space-based (i.e., non-Earth-based) mausoleum systems and associated methods.

Historically, the lives of deceased individuals have been celebrated and honored with elaborate burials and memorial services. A variety of known methods for the burial of deceased individuals include, for example, the construction and use of underground graves, the construction and use of encapsulating tombs or mausoleums, the burial of individuals at sea, and cremation. Typically, these burials and memorial services include eulogies, prayers, and other reflections on the life of the deceased individual. In many cases, the burials include the erection of permanent memorials, testaments, and/or remembrances, e.g. grave stones, to provide family and friends of the deceased individual with a site to visit in memory of the deceased individual. In general, all of these burials and memorial services are for the benefit of the family and friends of the deceased individual. Planning for the services may also provide peace of mind for an individual during his or her life.

Recently, the assignee of the present invention, Celestis, Inc. (www.spaceburials.com) has made great strides in systems and methods for celebrating and honoring the lives of individuals upon their deaths. Celestis has successfully launched cremation/burial space flights including the space cremation/burials of celebrities Timothy Leary and Gene Roddenberry in which the ashes of deceased individuals have been sent into orbit around the Earth and/or hard-landed on the surface of the Moon.

What is still needed are improved methods for celebrating, honoring, memorializing, and remembering our loved ones after their death. What is also needed are systems and methods for performing space cremation/burials in a relatively simple, cost-effective, and yet dignified manner.

### SUMMARY OF INVENTION

The present invention overcomes various limitations and shortcomings of conventional burial systems and methods, including existing space-based cremation/burial systems and methods. The present invention provides space-based mausoleum systems and associated methods.

In one embodiment of the present invention, a space-based mausoleum system includes a cabinet-like structure, a plurality of compartments disposed within the cabinet-like structure, and a plurality of containers disposed within the plurality of compartments, wherein the plurality of containers are operable for housing the remains of a plurality of deceased individuals. The cabinet-like structure can be fixedly or removably attached to a spacecraft, orbited around the Earth, or located upon the surface of a space-based body.

In another embodiment of the present invention, a space-based cremation/burial method includes providing a cabinet-like structure, providing a plurality of compartments disposed within the cabinet-like structure, providing a plurality of containers disposed within the plurality of compartments, and disposing the remains of a plurality of deceased individuals within the plurality of containers. The method also includes fixedly or removably attaching the cabinet-like structure to a spacecraft, orbiting the cabinet-like structure around the Earth, or locating the cabinet-like structure upon the surface of a space-based body.

### BRIEF DESCRIPTION OF THE DRAWINGS

The present invention is illustrated by way of example, and not limitation, in the accompanying figures, in which:

FIG. 1 is a schematic diagram of one embodiment of a space-based mausoleum system of the present invention;

FIG. 2 is a block diagram of one embodiment of a space-based cremation/burial method of the present invention.

FIG. 3 is a schematic diagram of another embodiment of the space-based mausoleum system of the present invention;

FIG. 4 is a schematic diagram of a further embodiment of the space-based mausoleum system of the present invention;

FIG. 5 is a schematic diagram of a further embodiment of the space-based mausoleum system of the present invention; and

FIG. 6 is a schematic diagram of a further embodiment of the space-based mausoleum system of the present invention.

### DETAILED DESCRIPTION

Preferred embodiments of the present invention provide space-based mausoleum systems and associated methods for the storage of the remains of a plurality of deceased individuals and, preferably, only a portion of the remains of each of the plurality of deceased individuals.

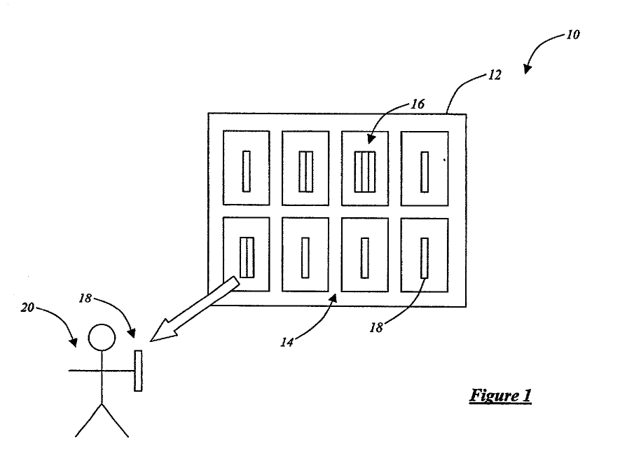

Referring to FIG. 1, in one embodiment of the present invention, the space-based mausoleum system 10 includes a cabinet-like structure 12 having a plurality of compartments 14. These compartments 14 may be drawers, lockers, sealable chambers, or the like and are operable for housing the remains of one or more deceased individuals. Each of the plurality of compartments 14 can have a substantially rectangular shape when viewed from the front (as illustrated in FIG. 1). Alternatively, each of the plurality of compartments 14 can have a substantially circular, triangular, pentagonal, hexagonal, hectagonal, octagonal, or other polygonal shape when viewed from the front. For example, a plurality of honeycomb-like compartments 14 can be used to maximize the use-efficiency of compartment space. The cabinet-like structure 12 and the plurality of compartments 14 can be made of a metal, a composite material, or any other material suitable for travel into space.

Each of the plurality of compartments 14 can be used to house the remains of one deceased individual, on a one-to-one basis. Alternatively, each of the plurality of compartments 14 can be used to house the remains of more than one deceased individuals. For example, the remains of family members can be disposed within the same compartment 14. In an exemplary embodiment of the present invention, a section of compartments 16 (e.g. an entire row, column, section, or wall of drawers, lockers, sealable chambers, or the like) can be restricted to predetermined groups, categories, or classes of individuals. For example, a section of compartments 16 can be restricted to a given family or group of families, members of a social group or club, military personnel, individuals of a given religion or nationality, or the like. The plurality of compartments 14 can also be organized according to price (i.e., a variable pricing scheme can be implemented). For example, some of the plurality of compartments 14 may be larger or include enhanced features, such that the price of those compartments 14 is higher. One enhanced feature includes the ability to place items other than ashes in the compartment 14, such as personal belongings of the deceased individual. Compartments 14 made of precious metals, such as platinum, gold, silver, bronze, or the like, as well as those with special doors, walls, identification plates, placards, or the like, can have a higher price.

In various embodiments of the present invention, some or all of the plurality of compartments 14 are configured to contain contents in addition to the remains of a deceased individual, such as electronic data about or related to the deceased individual. This electronic data can be stored on a computer disk, computer chip, or other storage medium. The electronic data can include, for example, photographs of the deceased individual, statements by the deceased individual (stored on an electronic storage medium, sheet material, or by other means), genetic material and/or information related to the deceased individual (e.g. skin samples, hair samples, and related information), and/or other contents related to the deceased, the deceased's family, and/or the deceased's life and interests.

Preferably, the plurality of compartments are labeled and/or otherwise identified with indicia in order to facilitate the visual identification of each of the plurality of compartments 14 and the association of each of the plurality of compartments 14 with the deceased individual whose remains are contained therein. Preferably, each of the plurality of compartments 14 is configured to house at least one container 18 that is constructed to hold some or all of the remains of one or more deceased individuals. Thus, the entire space-based mausoleum 10 can be used to store a plurality of such containers 18 in a plurality of compartments 14.

In various preferred embodiments of the present invention, the remains of the deceased individual include ashes of the deceased individual. Optionally, only a small portion of the remains of a deceased individual are disposed within each container 18. In one illustrative example, between about 5 grams and about 10 grams of ashes of a deceased individual are disposed within each container 18. A large number of these containers 18 are incorporated in the space-based mausoleum 10. The size and weight of the plurality of containers 18 are limited, limiting the size and weight of the cargo or load that is delivered to the space-based mausoleum. In other embodiments of the present invention, the ashes of an entire deceased individual, or substantially an entire deceased individual, can be contained within each of the plurality of containers 18 or within each of the plurality of compartments 14. Optionally, the remains of an entire deceased individual, or substantially an entire deceased individual can be dehydrated, freeze-dried, or otherwise pre-processed and stored in the space-based mausoleum.

Referring again to FIG. 1, the space-based mausoleum 10 includes a plurality of compartments 14 that are constructed to house the remains of one or more deceased individuals. Each of the plurality of compartments 14 can include separate cavities or cells within a cabinet-like structure 12. Individuals doors (not shown) can be provided to close the front of each cavity or cell, enclosing the respective compartments 14. Remains of deceased individuals are disposed within a plurality of containers 18 that are placed into the plurality of compartments 14 either manually or with the aide of a mechanical/electrical delivery system. For example, an individual 20, such as an astronaut, a cosmonaut, a priest, or the like, can place the remains of the deceased individuals into the plurality of compartments 14.

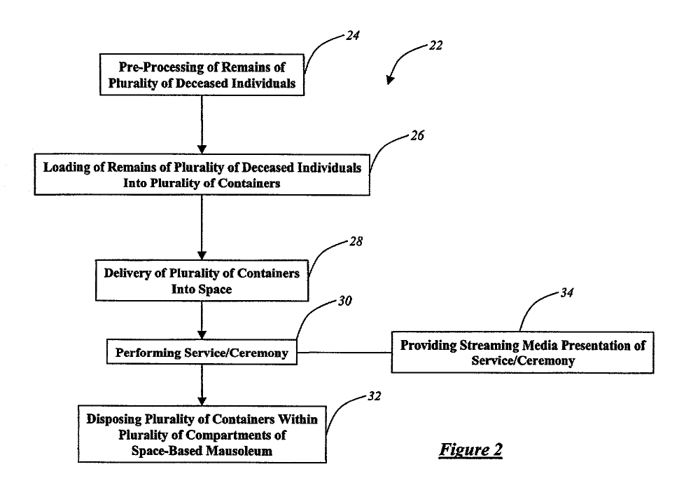

Referring to FIG. 2, in another embodiment of the present invention, a space-based cremation/burial method 22 includes pre-processing the remains of a plurality of deceased individuals. (Block 24). As described above, this can include cremating, dehydrating, or freeze-drying the remains of the plurality of deceased individuals. The pre-processed remains of the plurality of deceased individuals are then loaded into the plurality of containers 18 (FIG. 1). (Block 26). Next, the plurality of containers 18 are delivered into space via a suitable delivery system. (Block 28). Once the plurality of containers 18 are delivered into space, a service or ceremony is performed (Block 30) and the plurality of containers 18 are disposed within the plurality of compartments 14 (FIG. 1) of the space-based mausoleum 10 (FIG. 1) (Block 32). Optionally, the service or ceremony surrounding the placement of the remains of the plurality of deceased individuals into the plurality of compartments 14 can be recorded via space-based audio/video equipment proximate to the space-based mausoleum 10 and an audio/video broadcast, streaming media presentation, or on-line web cast (via the Internet) of the of the service or ceremony, or of an individual tending to the space-based mausoleum 10, can be transmitted to and observed by family and friends on Earth, via a radio-communications link, a satellite, video displays, and/or their personal computers. (Block 34). Preferably, the service or ceremony is transmitted to and observed by family and friends in substantially real-time. In the case of a streaming media presentation or on-line web cast, the playback of the audio and/or video depictions of the service or ceremony can be carried out using a suitable streaming media player executing on a user's local computer or acting as a plug-in module for a browser application. Examples of suitable streaming media players include, but are not limited to, the Microsoft MediaPlayer, the Apple Computer QuickTime player, and the Real Networks RealPlayer.

In a variety of preferred embodiments, the space-based mausoleum 10 is located in a space-based environment, such as on a mobile spacecraft, on an orbiting spacecraft such as a satellite or space station, or on the surface of a space-based body such as the Moon, another planet, an asteroid, etc. The space-based mausoleum 10 can first be erected in a space-based environment and then, periodically, the remains of deceased individuals can be added to the space-based mausoleum 10. Preferably, the space-based mausoleum 10 is human-tended. The space-based mausoleum 10 is constructed such that humans (e.g. astronauts, cosmonauts, priests, and other individuals) can a) visit the site of the space-based mausoleum, b) access the plurality of compartments 14 of the space-based mausoleum, c) manually place contents (e.g. remains and/or other materials) within the plurality of compartments 14 of the space-based mausoleum 10, and/or d) perform memorial services or ceremonies proximate to the space-based mausoleum 10. Preferably, the space-based mausoleum 10 is adapted such that individuals tending thereto can continue to revisit the space-based mausoleum 10. A plurality of missions can be conducted during which each of the plurality of compartments 14 of the space-based mausoleum 10 can be filled with contents.

In the case of an Earth-orbiting space-based mausoleum 10, the space-based mausoleum 10 can be provided on a spacecraft that follows any orbital path. For example, a decaying low-earth orbital path may be followed. Alternatively, a geo-synchronous orbital path may be followed, substantially fixing the space-based mausoleum 10 in a location over the surface of the Earth. Among other things, this would enable the location of the space-based mausoleum 10 to be substantially fixed with respect to the ground, providing a substantially consistent location for viewing of the space-based mausoleum 10 (via a telescope or other suitable means).

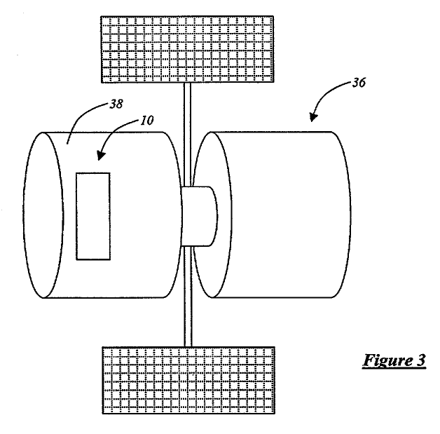

Referring to FIG. 3, in a further embodiment of the present invention, the space-based mausoleum 10 can be incorporated into a space station 36, such as the existing United States Space Station Freedom or the Russian Space Station Mir. The space-based mausoleum 10 can be incorporated into an otherwise decommissioned (i.e., non-operative or unusable) module or section 38 of the space station 36.

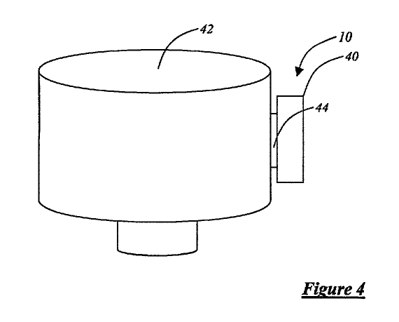

Referring to FIG. 4, in a further embodiment of the present invention, the space-based mausoleum 10 can be incorporated as an attachment 40 (i.e., an externally attached module or section, or the like) to an existing space station, satellite, or other spacecraft 42. Optionally, the space-based mausoleum 10 can be attached to the space station, satellite, or other spacecraft 42 via a hard-connection or a tether 44.

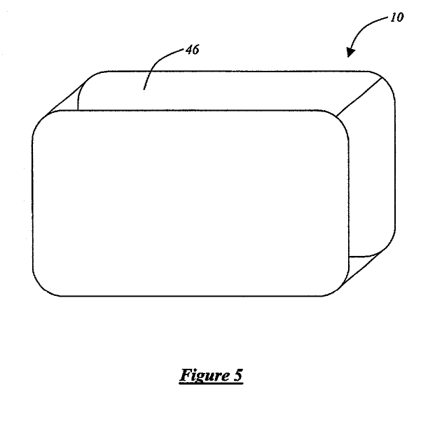

Referring to FIG. 5, in a further embodiment of the present invention, the space-based mausoleum 10 can be provided as an independent spacecraft or the like. For example, the space-based mausoleum 10 can include an inflatable structure 46 that can be transported to a predetermined location in a compact state and inflated for use.

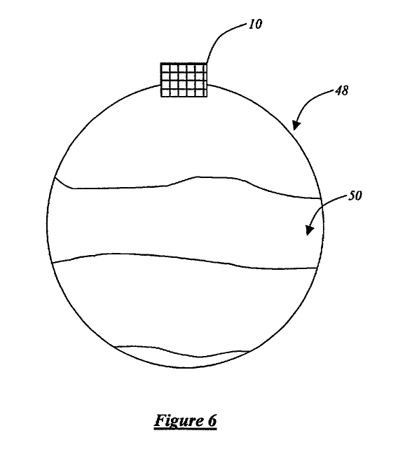

Referring to FIG. 6, in a further embodiment of the present invention, the space-based mausoleum 10 can be provided on the surface 48 of a non-Earth-based body 50, such as the surface of the Moon, another planet, an asteroid, or the like.

In various preferred embodiments, the space-based mausoleum 10 is launched and/or erected separately from some or all of the remains of the deceased individuals to be disposed within the space-based mausoleum. Each of the plurality of compartments 14 (FIG. 1) of the space-based mausoleum 10 can be pre-purchased by or on behalf of the deceased individual i.e., each of the plurality of compartments 14 of the space-based mausoleum 10 can be reserved in advance of one's passage or death. The space-based mausoleum 10 is launched and/or erected upon the pre-purchase of a sufficient percentage or all of the available compartment space. Thus, the space-based mausoleum 10 can be managed economically, decreasing risk and out-of-pocket expenses.

Preferably, the space-based mausoleum 10 is used to provide perpetual care for the remains of a plurality of deceased individuals. The location of the space-based mausoleum 10 enhances the duration of the space-based mausoleum 10 and its contents, eliminating Earth-based environmental contaminants. Notably, the contents of the space-based mausoleum can be retained in a substantially unaltered state for an extremely long duration, enabling, for example, long-term “mummification” to take place and/or the retention of portions or all of the bodies of deceased individuals.

In various preferred embodiments of the present invention, a system for delivering the remains of a plurality of deceased individuals to the space-based mausoleum 10 include one or more Earth-based facilities. Among other things, these terrestrial facilities can be used to handle, prepare, and package the remains of a plurality of deceased individuals for transport to the space-based mausoleum 10. In some cases, the remains of a deceased individual can be stored in a terrestrial facility until it is desired to transport the remains of the deceased individual to the space-based mausoleum. For example, the remains of a husband can be stored in a terrestrial facility until his wife passes or dies, at which time the remains of both spouses can be transported to the space-based mausoleum 10 in a single launch mission. Likewise, the remains of a plurality of deceased individuals may be transported to the space-based mausoleum when a predetermined number of containers 18 (FIG. 1) have been filled.

Although the present invention has been described and illustrated in conjunction with preferred embodiments and examples thereof, other embodiments and examples may achieve the same results and/or perform similar functions. Accordingly, changes in and modifications to the present invention will be apparent to those of ordinary skill in the art and the following claims are intended to cover all such equivalent embodiments and examples.

1. A space-based mausoleum system, comprising:
a cabinet-like structure;
a plurality of compartments disposed within the cabinet-like structure;
a plurality of containers disposed within the plurality of compartments; and
wherein the plurality of containers are operable for housing the remains of a plurality of deceased individuals.

2. The space-based mausoleum system of claim 1, wherein the cabinet-like structure is fixedly attached to a spacecraft.

3. The space-based mausoleum system of claim 1, wherein the cabinet-like structure is removably attached to a spacecraft.

4. The space-based mausoleum system of claim 1, wherein the cabinet-like structure is in orbit around the Earth.

5. The space-based mausoleum system of claim 1, wherein the cabinet-like structure is located upon the surface of a space-based body.

6. The space-based mausoleum system of claim 1, wherein the remains of the plurality of deceased individuals are cremated remains.

7. The space-based mausoleum system of claim 1, wherein the remains of the plurality of deceased individuals are dehydrated remains.

8. The space-based mausoleum system of claim 1, wherein the remains of the plurality of deceased individuals are freeze-dried remains.

9. A space-based cremation/burial method, comprising:
providing a cabinet-like structure;
providing a plurality of compartments disposed within the cabinet-like structure;
providing a plurality of containers disposed within the plurality of compartments; and
disposing the remains of a plurality of deceased individuals within the plurality of containers.

10. The space-based cremation/burial method of claim 9, further comprising fixedly attaching the cabinet-like structure to a spacecraft.

11. The space-based cremation/burial method of claim 9, further comprising removably attaching the cabinet-like structure to a spacecraft.

12. The space-based cremation/burial method of claim 9, further comprising orbiting the cabinet-like structure around the Earth.

13. The space-based cremation/burial method of claim 9, further comprising locating the cabinet-like structure upon the surface of a space-based body.

14. The space-based cremation/burial method of claim 9, wherein the remains of the plurality of deceased individuals are cremated remains.

15. The space-based cremation/burial method of claim 9, wherein the remains of the plurality of deceased individuals are dehydrated remains.

16. The space-based cremation/burial method of claim 9, wherein the remains of the plurality of deceased individuals are freeze-dried remains.
